(19) United States
(12) Patent Application Publication
(10) Pub. No.: US 2024/0078524 A1
(43) Pub. Date: Mar. 7, 2024

(54) SYSTEM AND METHOD FOR PROVIDING SELECTIVE SAVINGS AT A RETAIL OUTLET

(71) Applicant: Pink Granite Inc., Falmouth, MA (US)

(72) Inventors: David Lidman, Cotuit, MA (US); David Newton, Cotuit, MA (US); Jack Newton, Duxbury, MA (US); Keith Lapointe, North Attleboro, MA (US); Greg Segall, Watertown, MA (US)

(21) Appl. No.: 18/506,798

(22) Filed: Nov. 10, 2023

Related U.S. Application Data
(63) Continuation-in-part of application No. 17/650,068, filed on Feb. 4, 2022.
Application No. 17/650,068 is a continuation-in-part of application No. 16/990,093, filed on Aug. 11, 2020, now abandoned.
(60) Provisional application No. 63/265,082, filed on Dec. 7, 2021.

(51) Int. Cl. G06Q 20/10; G06Q 20/12; G06Q 30/0279

(52) U.S. Cl. CPC G06Q 20/10; G06Q 20/12; G06Q 30/0279

(57) ABSTRACT

A networked and computerized system is disclosed for providing funding allocations, savings, and discounts to certain individuals at the time of purchase from a retail outlet. Specifically, savings and discounts may be provided to SNAP recipients (such as products not eligible for SNAP discounts) by manufacturers when certain products are purchased. The individuals eligible for such discounts are determined based upon the payment information and/or based on their eligibility under the SNAP program. Manufacturers may provide credits back to the retailer as compensation for the savings and discounts. Discounts can be taken at the time of purchase or may be transferred to another account. Funding allocations may be provided to a digital wallet of a qualifying consumer to assist with the purchase of qualifying products. Funding allocations may be made by manufacturers before the purchase transaction takes place, such that no credit need be provided to the retailer.

### FIELD

The disclosed system and method relates to financial systems utilized in connection with retail distribution of products. More particularly, it relates to a system for providing selective funding, savings, or discounts based upon a status of a purchaser's payment account.

### BACKGROUND

The Supplemental Nutrition Assistance Program (SNAP) combines federal, state and private entities in order to provide food to the poor and disadvantaged. SNAP is funded principally by the federal government. The states determine eligibility within defined federal guidelines and distribute funds to qualifying families and individuals. States may also provide additional funds. Recipients can use the funds to purchase items at ordinary retail outlets. There are limits on the types of items which can be purchased with SNAP funds. For example, SNAP funds cannot be used to purchase alcohol. The retail outlet must exclude prohibited items from the sale and require a different form of payment for those items.

SNAP was formerly known as Food Stamps because the funds were distributed as paper coupons with designated values. Recipients would use the coupons like cash to purchased allowed items. The retail outlet would then redeem the coupons with the state to collect the funds. There were many problems with the use of coupons. Coupons could be lost or stolen and required a tedious process for replacement and a loss of food for those most in need. Coupons could be counterfeited or improperly obtained. The needy were preyed upon by persons purchasing coupons at less than face value to get ready cash or for other purchases. Retail outlets had additional costs relating to the process for redeeming coupons. Also, the entire process created a stigma towards persons who used the coupons for purchases. Such persons were easily identifiable to other customers at retail outlets.

In the late 1990s, in order to address many of these problems and to reduce the administrative expenses of the program, coupons were phased out and replaced with Electronic Balance Transfer (EBT). EBT uses a card with a magnetic strip or a chip, identical to a credit or debit card, for the purchase of allowed items under SNAP. Most states also distribute cash assistance, including Temporary Assistance for Needy Families (TANF) and unemployment benefits, through the same EBT cards. The states work with banks to create and maintain accounts for recipients to receive and spend their SNAP and cash benefits. Benefits are deposited by the states into an account at a participating bank for the recipient. The recipient receives a EBT debit card for accessing the funds in the account. The debit card may be used for purchases at a retail outlet and may be used to obtain cash, at a bank, ATM or as cash back in a purchase. Funds in the account can only be used in accordance with the rules of the program providing the funds. For example, SNAP funds are limited to the purchase of food. Those funds cannot be used for other purposes or removed as cash. Other funds in the account may be able to be removed as cash.

As a public-private partnership, SNAP is able to provide benefits to needy people in a more efficient manner than coupons. While retail outlets and banks are able to provide some benefits in connection with the process, it would be helpful if other companies could also provide contributions to help the needy in relation to SNAP. In particular, a need exists for product manufacturers to participate in the program and provide discounts and savings to persons in the SNAP program.

Nevertheless, even the SNAP program has its disadvantages and limitations. For example, EBT cards now have some of the stigma that was associated with the use of coupons. SNAP is limited to certain products and excludes prepared foods, personal care items, diapers, and various other products for which families may have a high need. SNAP also has limited transparency, and it is often difficult to know who SNAP is helping and how. Therefore, the precise impact of SNAP is unclear. Further, some fraud and/or abuse is still possible through the SNAP system.

Therefore, a need exists to improve upon the way benefits are provided to needy families, to improve the allocation of benefits, and maximize the incentives to participate in charitable contributions whilst eliminating the stigma associated with receiving assistance.

### SUMMARY

A computerized discount system including at least one manufacturer system providing discount information for products, a point of sale register generating a total of purchases, and a receiver located within the point of sale register, the receiver receiving and storing the discount information from the at least one manufacturer system, wherein the point of sale register identifies products subject to discounts based on the discount information, receives purchaser information, determines eligibility of a purchaser to receive discounts based upon the purchaser information, and applies the discounts to the total of purchases based on the eligibility of the purchaser, wherein the point of sale register communicates the discounts to the at least one manufacturer system, and wherein the at least one manufacturer system applies a credit to an account of a retail outlet in the amount of the discounts

A method for operating a computerized discount system that provides payments from an account of a purchaser to a retail outlet, the method comprising the steps of: providing discount information for products from at least one manufacturer system, the discount information including any number of a product, a discount amount, and a specified group of purchasers eligible to receive the discount amount upon purchase of the product, accumulating on a register purchase information formed of a list of products being purchased by the purchaser and accompanying prices, receiving and storing the discount information from the at least one manufacturer system on a receiver in the register, identifying products subject to one or more discounts based on the discount information, receiving payment information with a payment device connected to the register, determining whether the purchaser is within the specified group of purchasers based upon the payment information, applying the discounts to the list of products based on eligibility of the purchaser, communicating the one or more discounts to the at least one manufacturer system, and applying a credit from the at least one manufacturer system to an account of the retail outlet in the amount of the one or more discounts.

A method for operating a computerized discount system in a retail outlet, the method comprising the steps of: providing discount information for products from at least one manufacturer system, the discount information including any number of a product, a discount amount, and a specified group of purchasers eligible to receive the discount amount upon purchase of the product, receiving on a register purchase information of products to be purchased by a purchaser, receiving and storing the discount information from the at least one manufacturer system on a receiver in the register, identifying products subject to one or more discounts based on the discount information, receiving account information with a customer input device connected to the register, determining whether the purchaser is within the specified group of purchasers based upon the account information, applying the discount information to the purchase information of products based on eligibility of the purchaser, and communicating the one or more discounts to the at least one manufacturer system, and the at least one manufacturer system applying a credit to an account of the retail outlet in the amount of the one or more discounts.

A computerized point of sale system including a receiver for receiving and storing discount information from at least one manufacturer, the discount information identifying products subject to discounts available to a specified group of purchasers, and a register attached to the receiver for generating a total of purchases, receiving payment information, and determining whether a purchaser is in the specified group of purchasers based upon the purchaser's eligibility for SNAP discounts.

A method for operating a computerized point of sale system receiving payments from at least one account to at least one retail outlet, the method comprising the steps of: receiving and storing in a receiver of the point of sale system product discount information from at least one manufacturer, the product discount information including at least one product, a corresponding discount amount, and a specified group of purchasers eligible to receive the discount amount upon purchase of the at least one product, generating a total of purchases at a register attached to the receiver, receiving purchase information when an owner of the at least one account makes a purchase using the at least one account, determining whether the owner of the at least one account is in the specified group of purchasers based upon the owner's eligibility for SNAP discounts.

### BRIEF DESCRIPTION OF THE DRAWINGS

Various aspects and advantages will become apparent upon review of the following detailed description and upon reference to the drawings in which:

FIG. 1 is a block diagram illustrating a system of connected computerized components for implementing the disclosed methods.

FIG. 2 is a block diagram illustrating the operation of a point of sale system.

FIG. 3 is a block diagram illustrating the operation of an account system.

FIG. 4 is a block diagram illustrating another operation of an account system.

FIG. 5 is a block diagrams illustrating another operation of an account system.

FIG. 6 is a block diagram illustrating a system of connected computerized components for implementing the disclosed methods.

FIG. 7 is a block diagram illustrating a system of connected computerized components for implementing the disclosed methods.

FIG. 8 is a block diagram illustrating an operation of a funding allocation system.

FIG. 9 is a block diagram illustrating an operation of a funding allocation system.

FIG. 10 is a block diagram illustrating an operation of a funding allocation system.

FIG. 11 is a block diagram illustrating an operation of a funding allocation system.

### DETAILED DESCRIPTION

The disclosed includes a system and method for providing savings or discounts to a specified group of people. In particular, the savings or discounts may be provided to a specified group of recipients, such as discount recipients (e.g., SNAP recipients) by manufacturers of purchased products. When a discount recipient purchases the designated products, the discounts may be provided automatically by the system without additional actions being required by the purchaser or the cashier.

The system includes a point of sale system operating to provide discounts to discount recipients (e.g., SNAP recipients). The identity of discount recipients may be determined automatically from the payment used by the purchaser. Payment information, either from an EBT card or from the payment network which processes the payment, may identify the purchaser as a discount recipient and may apply the discounts to the purchase. The discount may be transferred to another account rather than being applied to the purchase. The point of sale system may receive discount information from the manufacturer.

The system may include an account system connected by a network to the point of sale system. The account system may provide payments in connection with purchases at the point of sale system. The account system may receive purchase information from the point of sale system regarding products being purchased. The purchase information may include a list of items being purchased. The account system may apply manufacturer discounts to payments and/or accounts when designated products are purchased.

The account system may receive discount information from the manufacturer. The purchase information may include an amount of manufacturer discounts determined by the point of sale system.

The account system may apply manufacturer discounts to the payment account of the purchaser (e.g., an eligible purchaser). The account system may apply the manufacturer discount to a second account separate from the payment account of the purchaser.

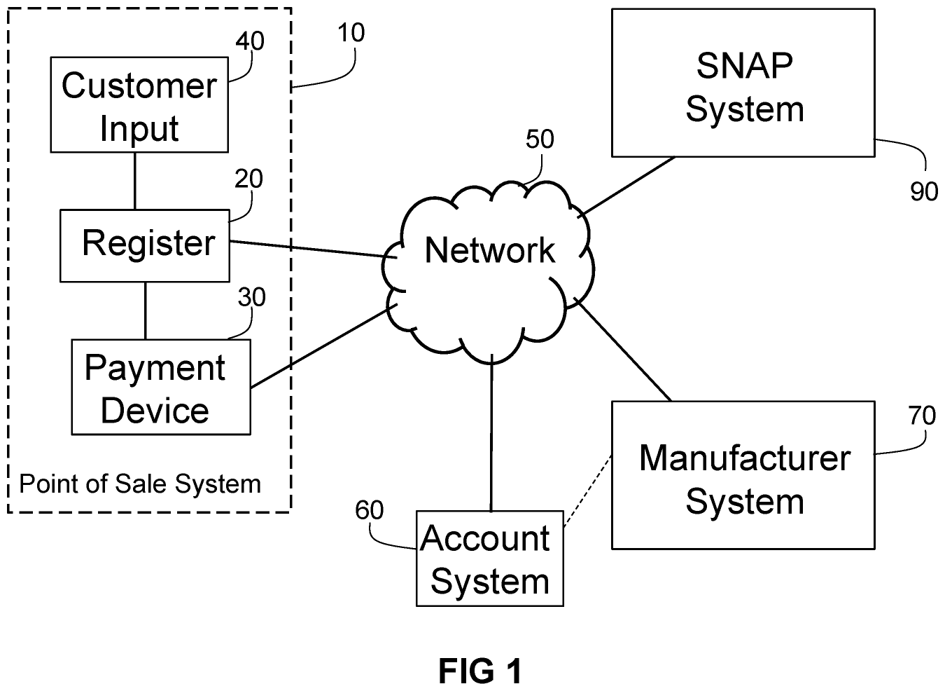

Various embodiments of the disclosed present system and method are illustrated in FIGS. 1-5. FIG. 1 represents a system. The physical structure and interconnections of various components are known to a person of ordinary skill in the art. Known components may be programmed in a novel way in order to perform functions as described in this disclosure but not previously known or used in connection with such components. The components and any unique functions and/or programming may be described herein.

As show in FIG. 1, a point of sale system 10 (e.g., for use at a retail outlet) may include a register 20 and a payment device 30. The point of sale system 10 may also include a customer input device 40. The point of sale system 10 may be connected through a wired or wireless network 50 to an account system 60. Either the register 20 or the payment device 30 may be connected to the network 50. A manufacturer system 70 may be connected to either the point of sale system 10 or the account system 60. A SNAP system 90 may be connected through a wired or wireless network 50.

The point of sale system 10 may perform many functions as are known to a person of ordinary skill in the art. The register 20 may be operated to receive inputs for products to be purchased. These inputs may include reading barcodes, entering product numbers, or any other known method for receiving product information. The register 20 may use internal data to determine prices for the entered products. The prices may include discount or savings as provided by the retail outlet based upon the products or upon the identity of the customer. The customer may be identified either by an input on the register or using the customer input device 40. The customer may input a loyalty account number, swipe a magnetic strip on a loyalty card, or scan a bar code on a loyalty card with the customer input device 40. Many retail outlets provide discounts on products for members of their loyalty program. Discounts may be provided when the customer is properly identified (e.g., applicable discounts may be accumulated). The customer may also use manufacturer coupons to obtain discounts. The manufacturer coupons may be entered into the register and information in the internal storage may be used to determine the amount of any discounts applicable to the presented coupons.

After all discounts have been applied, a total amount due may be presented to the customer for payment. Payment may be made through the payment device 30. The payment device 30 may be incorporated into the register 20 or may be a physically separate device attached to the register 20 for communication with the register 20. The payment device 30 may be operated by the cashier or by the customer. The payment device 30 may be used to enter payment information for electronic payments to the retail outlet. The payment device 30 may include a magnetic strip reader, a chip card reader, or a proximity reader for obtaining account information from a card or device of the customer. The payment device 30 may include a keyboard or pin pad for entering additional information necessary to verify the identity of the customer. The payment device 30 (directly or through the register 20) may transfer account information and purchase information to an account system 60 via network 50. The network 50 may communicate with an account system 60 (e.g., transmitting data), such as a bank or credit institution, and may determine whether the customer information is accurate, whether the account exists, and/or whether the account has sufficient funds or credit to complete the purchase. The account system 60 may provide authorization for the purchase.

A manufacturer system 70 may provide information about discounts from a manufacturer which may be applicable to specified customers, specifically discount recipients (e.g., aid recipients). Manufacturer discounts may operate in a manner similar to manufacturer coupons. When a discount recipient purchases a designated product, a discount may be applied to the total purchase amount due. The number and amount of such discounts may be periodically processed by the retail outlet and may be provided periodically to the manufacturer. The manufacturer may pay the retail outlet for the amount of the discounts, or may provide a credit for the amount to be used on future purchases or amounts due. Manufacturer system 70 may communicate to the point of sale system 10 the products and the amounts of discounts (e.g., transmitting product discount information). Similar systems are known in connection with coupons where the manufacturer provides barcodes, products, and coupon amounts to retail outlets in order to process coupons. However, in accordance with this disclosure, neither physical nor electronic coupons are used. Instead, the discounts may be applied upon identification of a discount recipient as described in this disclosure.

A SNAP system 90 may provide information about discounts for SNAP eligible products. When a customer is identified in any manner as described in this disclosure, register 20 and/or payment device 30 may communicate with SNAP system 90. The SNAP system 90 may verify whether the customer is eligible for SNAP discounts. The SNAP system 90 may verify whether the products purchased by the customer are eligible for SNAP discounts. Where a customer is eligible and/or at least some of the products to be purchased are eligible for SNAP discounts, the SNAP system 90 may communicate discount information to the register 20 and/or the payment device 30, and the SNAP discounts may be applied to the purchase total, so as to reduce the amount of money due for the sale of products.

Products eligible for SNAP discounts may still be eligible for other discounts, such as discounts provided by the manufacturer system 70, coupons, in-store credit, or other forms of credit. A customer who has been identified as eligible for SNAP discounts, but who is purchasing products that are not eligible for SNAP discounts may still be eligible for other discounts, such as discounts provided by the manufacturer system 70, coupons, in-store credit, or other forms of credit. A customer who isn't purchasing SNAP eligible products may be eligible for other discounts by virtue of being identified as a person eligible for SNAP discounts. A customer who isn't purchasing SNAP eligible products and who isn't a person eligible for SNAP discounts may be eligible for other discounts (e.g., fewer discounts than a SNAP eligible person), or may be eligible for the same discounts, or may be eligible for no discounts. Providing discounts on products (e.g., products not eligible for SNAP discounts) may create greater customer loyalty and thereby improve the market share of the reseller who is using the point of sale system. Further, the reseller may increase their charitable tax deductions by providing discounts to those in need. The advantage of using the SNAP system 90 to identify customers eligible for SNAP discounts may be that no additional card (e.g., EBT card) is required beyond that which has already been provided as part of the SNAP program and the implementation of such a discount system would require no additional cost of implementation.

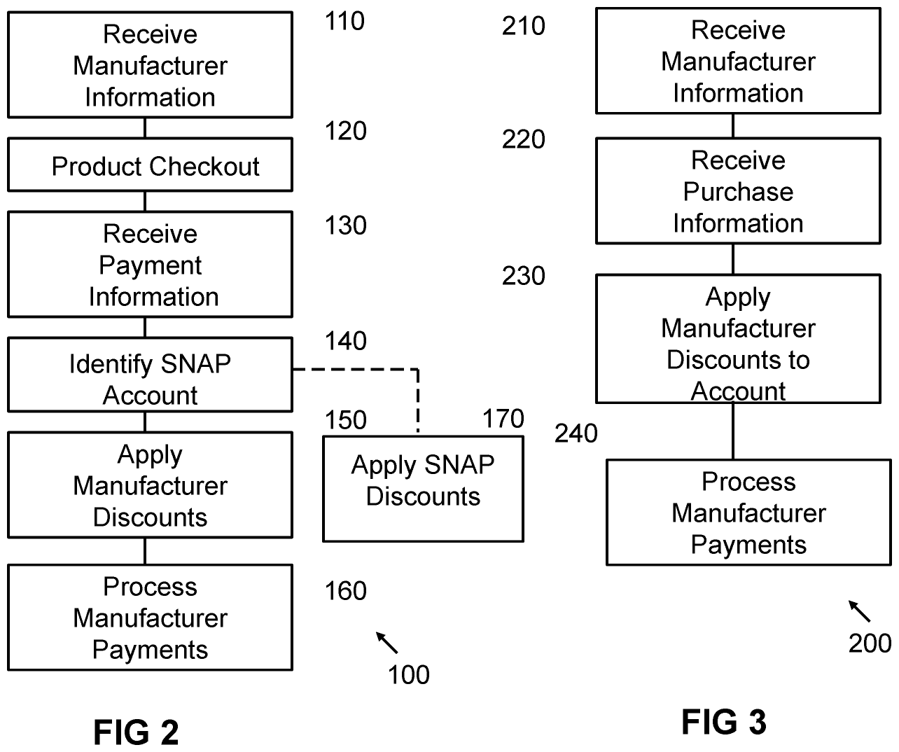

FIG. 2 is a block diagram illustrating the operation 100 of a point of sale system incorporating a register (e.g., register 20 of FIG. 1). The register 20 may perform each of the functions described herein or may communicate with other components of the point of sale system 10 to complete such functions. At step 110, the register 20 may receive discount information from the manufacturer system 70. The manufacturer system 70 may communicate discount information at such times as information is changed or updated. Discount information may include the products covered by a discount and the amount of the discount. The register 20 or point of sale system 10 may store the discount information in internal storage so that it can be retrieved when a corresponding product is purchased. The format and procedures for storing and retrieving discount information may be similar to those used for product prices and manufacturer coupons.

At step 120, the register 20 may perform a product checkout using known procedures and processes. Product information may be input into the register and the product prices and total amounts due may be determined.

At step 130, payment information may be received. As discussed above, payment information may be obtained through interaction of the register 20, payment device 30, network 50 and account system 60. Payment information, as may be received by the register 20 at step 130 may include at least account information (such as a credit card number, debit card number, electronic account, and source), an authorization code, and/or an authorized amount.

At step 140, the register 20 may identify a discount account (e.g., a SNAP account) based upon the payment information. Different mechanisms may be used to identify a discount account. First, account number information may identify a discount account. With credit cards, the first few numbers represent the type of card. VISA cards use different numbers than MasterCard, Discover and American Express. EBT cards may also use different numbers so that SNAP accounts can be identified. Second, the payment information received at step 130 may include an identification code for a discount account. The account system 60 may provide this identification code based upon the type of account associated with the account information provided to it. Third, the EBT card includes information identifying it as a discount account. The information may be incorporated into the magnetic stripe or chip used on the card. Fourth, a cashier may enter a code from the EBT card to identify a discount account. These mechanisms for identifying a discount account from the payment information are presented in no particular order. This disclosure is not limited to these mechanisms and may include any other similar mechanisms, or any other mechanisms known by a person of ordinary skill in the art useful for identifying a discount account.

If the payment information does not include a discount account, the purchase transaction is completed in a known manner.

If a discount account is identified, the register may perform additional steps as illustrated in FIG. 2, such as applying SNAP discounts to SNAP eligible products at step 170 and/or applying manufacturer discounts to eligible products at step 150. At step 150, the register 20 may apply manufacturer discounts to the transaction. Products may be eligible for SNAP discounts and/or manufacturer discounts. Where products are not eligible for SNAP discounts, products may be eligible for manufacturer discounts by virtue of the identification of the discount account (e.g., a SNAP eligible user may be denied SNAP discounts but given manufacturer discounts only because of his or her SNAP eligibility). The register 20 and/or payment device 30 may access internal storage to retrieve discount information relating to the purchased products (e.g., regarding manufacturer discounts). The register 20 and/or payment device 30 may receive discount information relating to the purchased products from the SNAP system 90 (e.g., regarding SNAP discounts). Discounts may be deducted from the total amount due and the account may be charged for the reduced amount. Thus, the discount recipient may be able to receive a reduced price provided by manufacturers for designated products.

At step 160, the register 20 (or the point of sale system 10) may process the discounts to receive payments from the manufacturer corresponding to the amount of the discounts provided (e.g., such that a payment may be deposited into an account of the retail outlet). Step 160 may be performed periodically rather than with each transaction (e.g., hourly, daily, weekly, monthly, or at normal time intervals). Step 160 may be performed using mechanisms and processes similar to processing of manufacturer coupons.

Manufacturer discounts may be processed and credited by the account system 60 rather than the register 20 (or point of sale system 10), such as using purchase information for the products being purchased. Therefore, if the register 20 identifies a discount account at step 140, it may send purchase information through the network 50 to the account system 60 at step 170. Purchase information may include barcode numbers or other information identifying the product purchased. Step 170 may be an alternative to steps 150 and 160. The transaction may be completed in the usual manner with the retail outlet receiving full payment for the purchases.

FIG. 3 is a block diagram illustrating a process 200 in an account system (e.g., account system 60 of FIG. 1) for processing discounts. At step 210, the account system 60 may receive manufacturer information from the manufacturer system 70. The manufacturer information may be identical to the information which would be provided to the point of sale system 10, including product numbers and discount amounts. The manufacturer information may be stored in internal storage in the account system 60 for later retrieval.

At step 220, the account system 60 may receive purchase information from the register 20 or point of sale system 10. The purchase information may include product numbers for products purchased in the transaction. With the product numbers, the account system 60 may determine and apply manufacturer discounts to the customer account at step 230. Manufacturer discounts may be determined by accessing the stored manufacturer information relating to the product numbers. Although discount benefits (e.g., SNAP benefits) may have limitations on their use, the manufacture discounts applied to the customer account may not have the same limitations. Therefore, the customer may be able to access the manufacturer discounts as cash or purchase of products outside the relevant limitations.

At step 240, the account system 60 may process the manufacturer discounts for payment from the manufacturer. The processing of manufacturer payments may be similar to the processes used by the register 20 or point of sale system 10 in obtaining payments.

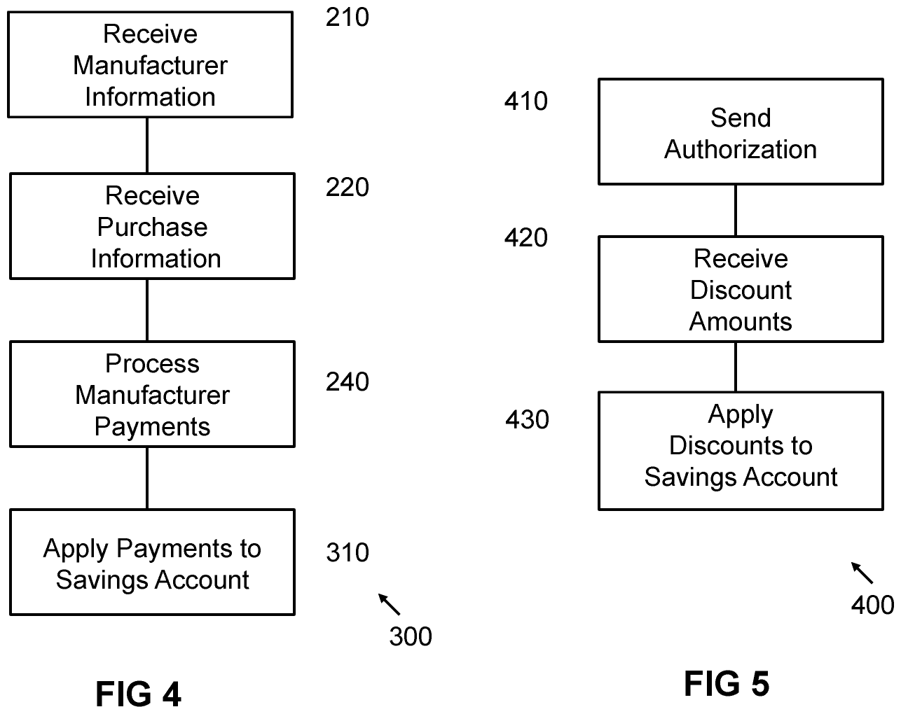

FIG. 4 is a block diagram illustrating a process 300 in an account system (e.g., account system 60). Here, the manufacturer discounts may not be applied to the same customer account from which the payment is made. Instead, the manufacturer discounts may be applied to a separate savings account. The process 300 in the account system 60 may be similar to process 200, as set forth with respect to FIG. 3. As with respect to process 200, the process 300 may receive manufacturer information (step 210) and purchase information (step 220). These steps may function identically to the steps discussed above with respect to FIG. 3. Similarly, the account system 60 may process manufacturer payments at step 240. At step 310, the manufacturer payments from a transaction may be taken as cash at the point of sale, or applied to a savings account. The savings account may be owned by and accessible to the purchaser, or may be owned by another person or entity designated by the purchaser. In this manner, the savings may be donated to another person or a charitable organization. The purchaser may further elect to have savings credited to their SNAP EBT account which is set up and managed by the SNAP system 90, or sent to the SNAP EBT account of another person.

FIG. 5 is a block diagram illustrating a process 400 in an account system (e.g., account system 60) for processing discounts. Here, the retail outlet may determine discounts and process manufacturer payments in the same manner as set forth in operation 100, as illustrated in FIG. 2. When a discount account is identified, the register 20 may send purchase information to the account system 60 (step 170 in FIG. 2) and further may apply the discounts to the purchase transaction. The purchase information may include discount amounts determined by the register 20. As set forth in FIG. 5, the account system 60 may send an authorization for a purchase transaction in step 410. The authorization may be for the amount of the purchase transaction less any discount amounts. At step 420, the account may be debited for the full amount of the purchase transaction. At step 430, the account system 60 may receive the discount amounts as part of the purchase information from the register 20. At step 430, the account system 60 may apply the discount amounts to a savings account. The savings account may be associated with the purchaser or another entity designated by the purchaser.

The system and method may have been described above with respect to recipients of discounts (e.g., SNAP recipients). The system is particularly useful for such persons in order to provide additional benefits from manufacturers who are willing to help those in need. However, the present system and method is not limited to SNAP recipients nor to manufacture discounts. Other types of customers can be accommodated in the system when the payment information or authorization information is used to identify accounts to which discounts may be applied. Discounts may also be provided by the retail outlet or other entities based upon the status of the customer.

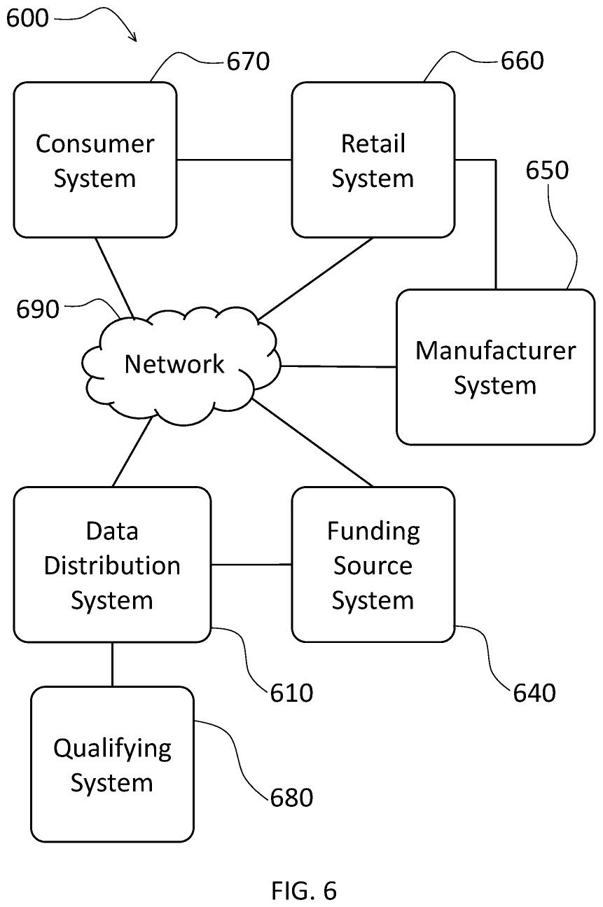

FIG. 6 illustrates a funding allocation system 600 for managing the disbursement, transfer, and/or allocation of funds to needy individuals and/or groups. Funding allocation system 600 may include a data distribution system 610 for managing and storing data and communication transmitted between the various elements of funding allocation system 600. Funding allocation system 600 may include a funding source system 640 for facilitating the collection of funding. Funding allocation system 600 may include a manufacturer system 650 for facilitating the collection of information about products made available for purchase. Funding allocation system 600 may include a retail system 660 (e.g., having one or more point-of-sale (POS) systems) for facilitating the purchase of products by a consumer user. Funding allocation system 600 may include a consumer system 670 to facilitate the use of funding by a consumer user to purchase products. Funding allocation system 600 may include a qualifying system 680 to facilitate the qualification of consumer users to determine their eligibility to receive funding for the purchase of products.

Funding allocation system 600 may include a network 690 (e.g., the internet) to facilitate communication between various elements of the system. Yet some communication may occur directly between elements of the system rather than through network 690 and/or through another network. It is understood that digital communications may be accomplished through the use of various computer technologies, including, without limitation, processors, modems, routers, and so forth.

Each system within funding allocation system 600 may represent a separate and distinct computer system. Funding source system 640 may represent one or more computer systems (e.g., a desktop computer having operating software), each controlled by a non-profit organization (NPO). Funding source system 640 may include software that enables funding to be received, managed, and/or dispersed (e.g., an NPO may use their funding source system 640 to transfer funds, such as funding data, to data distribution system 610 to be used for needy individuals and families).

Manufacturer system 650 may represent one or more computer systems (e.g., a mainframe computer), each controlled by a manufacturer. Manufacturer system 650 may include software that enables products and information about products to be received, cataloged, stored and/or transmitted (e.g., such as a PIM system, which may transmit the product information to the data distribution system 610).

Retail system 660 may represent one or more computer systems (e.g., a retail register), each controlled by a retailer. Retail system 660 may include software that enables products to be itemized, totaled, and purchased using payment from a consumer user and/or using funding (e.g., funding data) passed from funding source system 640 (e.g., retail system 660 may be periodically updated by data distribution system 610 with information about which products qualify for funding and/or the amount of funding available for the purchase of those products).

Consumer system 670 may represent one or more computer systems (e.g., a mobile phone), each controlled by a consumer user. Consumer system 670 may include software that enables products to be purchased using payment from the consumer user's financial account and/or using funding passed from funding source system 640 (e.g., consumer system 670 may receive an indication by the data distribution system 610 of the amount of money allocated for the consumer user's use to purchase products).

Qualifying system 680 may represent one or more computer systems (e.g., a plurality of systems for performing a background check, including, without limitation, a credit checking system, a criminal history checking system, a real estate default checking system, a system for checking demographics of the consumer user, and so forth), each utilized by the data distribution system 610 to qualify and/or determine the eligibility of consumer users to receive funding for the purchase of products. Qualifying system 680 may communicate with data distribution system 610 through a network (e.g., the internet). Qualifying system 680 may include software that determines eligibility of the consumer user to receive funding based on one or more conditions imposed on the use of the funding (e.g., data distribution system 610 may approve a consumer user to receive a funding allocation based on the one or more conditions, and the allocated funds (e.g., funding data) may appear in the consumer user's digital wallet, which allocation may be viewable and/or usable via consumer system 670).

Data distribution system 610 may represent a computer system (e.g., a network of servers), which coordinates the communications of the other elements of funding allocation system 600. Data distribution system 610 may include software that coordinates this communication. Data distribution system 610 may receive and store product information from one or more merchant systems 650 (e.g., in a product storage). Data distribution system 610 may receive and store funding data from funding source system 640 (e.g., in a funding storage). Data distribution system 610 may transmit product information to a retail system 660 (e.g., using an integration module). Data distribution system 610 may receive and store consumer personal information from one or more consumer users via consumer system 670 (e.g., in a consumer storage). Data distribution system 610 may qualify consumer users for use of funding based on the consumer personal information and based on conditions imposed on the use of funding (e.g., using a qualifying module). Data distribution system 610 may receive and store consumer qualification information from qualifying system 680 (e.g., in a qualifying storage). Data distribution system 610 may qualify consumer users for use of funding base on the consumer qualification information and based on conditions imposed on the use of the funding (e.g., based on conditions prescribed in a prebate module). Data distribution system 610 may transmit the eligibility of one or more consumer users to a retail system 660 (e.g., to a POS system in a brick and mortar store). Data distribution system 610 may receive transaction and/or purchase information of purchases from the retail system 660 (e.g., to an orders storage).

Data distribution system 610 may operate as a hub for data transmissions, reporting, and/or monetary transfers throughout the funding allocation system 600. This tracking of transmissions, reporting, and transfers may allow data distribution system 610 to keep accurate logs of all transactions and communications throughout the funding allocation system 600 (e.g., collected and stored in an audit log storage). Tracking may allow users (e.g., consumers, manufacturers, retailers, NPOs) to access information showing aggregate and/or specific statistics on exactly how funding was used, what products or services it went toward, how much was spent and who the funding was used to aid (e.g., a specified group of consumer users). Funding allocation system 600 may also overcome the limitation of having rebates available only for a select portion of products, or select categories of products, as is provided by SNAP and other prior art systems, because conditions on use of funding are set by the contributing entity who donated the funding (e.g., manufacturers) and/or by NPOs, rather than by the government (e.g., government bureaucrats). Therefore, contributing entities and/or NPOs will be able to see a need in the marketplace (e.g., prepared foods, personal care items, diapers, childcare services, etc.) not covered by SNAP and other prior art systems, and quickly respond, whereas government programs are inflexible and take many years, even decades to be changed, which has the effect of restricting freedom of choice in the marketplace. Funding allocation system 600 may also vastly increase where products and/or services may be purchased, whereas government programs and prior art systems may limit where permitted products may be purchased. Further the funding allocation system 600 may operate without the need for EBT cards and may alleviate the stigma associated with their use.

Funding source system 640 may facilitate the collection of funding. Funding may be collected in the form of one-time donations, recurring donations, legacy donations, tribute or memorial donations, stock donations, cash donations, electronic funds transfer (EFT), crypto donations, physical property donations, in-kind donations, grants (e.g., such as government grants), government aid (e.g., SNAP), and so forth.

Funding source system 640 may include the electronic devices of one or more NPOs and/or one or more contributing entities. NPOs may receive funding from a contributing entity. A contributing entity may include private individuals, corporate entities, non-profit entities, and/or government entities. Funding provided to NPOs (e.g., funding data) by contributing entities may make the contributing entity eligible for federal, state, and/or local tax benefits (e.g., due to the tax exempt status of the NPO under territorial tax laws). NPOs may then transfer funding into an account controlled by data distribution system 610 where funding in the account may be allocated based on any conditions set by either the NPO or the contributing entity (e.g., as part of a funding program). Nevertheless, contributing entities may bestow and/or transfer funding directly to the data distribution system 610 (e.g., without any tax benefits).

Contributing entities (e.g., manufacturers) and/or NPOs may set conditions on how the funding may be used in commerce. A contributing entity may set conditions on the use of funding when it is bestowed and/or transferred to the NPO. An NPO may create a funding program with pre-established conditions to which a contributing entity may bestow and/or transfer funding. A funding condition may limit use of funding to the purchase of specific products. A funding condition may limit use of funding to the purchase of a specific quantity of products. A funding condition may limit use of funding to specific individuals and/or groups. A funding condition may limit use of funding to a specific time frame (e.g., within a specified date range). A funding condition may limit use of funding based on Boolean-type operators (e.g., product A and product B, product A or product B, etc.). A funding condition may limit use of funding based on information obtained in a background check (e.g., based on household income).

Contributing entities (e.g., retailers) and/or NPOs may integrate their funding source system 640 with data distribution system 610 through a software application (e.g., a mobile application) installed on their funding source system 640 (e.g., one or more electronic devices). Contributing entities and/or NPOs may facilitate the bestowal and/or transfer of funding data to an NPO fund account within data distribution system 610 (e.g., via electronic funds transfer). Although held within data distribution system 610, the NPO fund account may be available to view through the software application on the funding source system 640 (e.g., via a user interface). One or more fund accounts may be stored on data distribution system 610 for each NPO (e.g., between about 1 fund account and 10,000 fund accounts, or more).

Manufacturer system 650 may include the electronic devices of one or more manufacturers (e.g., of one or more locations associated with a single manufacturer and/or of several manufacturers). Manufacturers may provide funding (e.g., funding data) as a contributing entity. A manufacturer may, as a contributing entity, set conditions on the funding they contribute. Manufacturers may integrate their manufacturer system 650 with data distribution system 610 through a software application (e.g., a computer program) installed on their manufacturer system 650 (e.g., one or more electronic devices at each manufacturer location). Manufacturer system 650 may allow manufacturers to catalog and store products and product information and to communicate product information to data distribution system 610 so that products are available for purchase using funding provided through the funding source system 640 (e.g., funding allocated from a fund account).

Retail system 660 may include the electronic devices of one or more retailers (e.g., one or more POS terminals). A single merchant (e.g., who is both manufacturer and retailer) may utilize manufacturer system 650 and retail system 660. Retailers may display various products and/or services (e.g., at a brick-and-mortar location, or on the internet through a product webpage) and may make various products and/or services available for purchase. Therefore, retail system 660 may be a physical electronic device used at the brick-and-mortar location (e.g., a register), or may be provided virtually through an online environment (e.g., via a website).

Retailers may integrate their retail system 660 with data distribution system 610 through a software application (e.g., a software program) installed on their retail system 660 (e.g., installed in each POS system). Retail system 660 may itemize and generate a total price for the selected products and/or services, may verify eligibility of the consumer user to receive funding allocated from the fund account, and may adjust the total price of the selected products to account for funding for which the consumer user qualifies. Retail system 660 may process payment. Retail system 660 may receive funding from data distribution system 610 (e.g., from the fund account) and/or from a financial account of the consumer user.

Consumer system 670 may include the electronic devices of one or more consumer users (e.g., a cellular phone and/or a smart device). Consumer users may integrate their consumer system 670 with data distribution system 610 through a software application (e.g., a mobile application) installed on their consumer system 670. During a shopping experience, a consumer user may collect a number of products and/or services to be purchased. During the checkout process, the consumer user may verify the consumer user's eligibility using consumer system 670, retail system 660, or both (e.g., communicating with data distribution system 610 to determine eligibility for receipt of funds under a funding program). The consumer user may have already undergone the qualification process, such that funds available under a funding program (e.g., held in a fund account) may already be allocated into a digital wallet of the consumer user for use by the consumer user. The consumer user may view, use, and/or interact with the consumer user's digital wallet on consumer system 670 (e.g., on a touch screen).

Electronic devices may include desktop computers, laptop computers, tablet computers, notebook computers, cellular phones, microcomputers, wearable computers, handheld computers, personal computers, workstations, single-board computers, portable computers, wireless computers, supercomputers, mainframe computers, netbooks, and so forth.

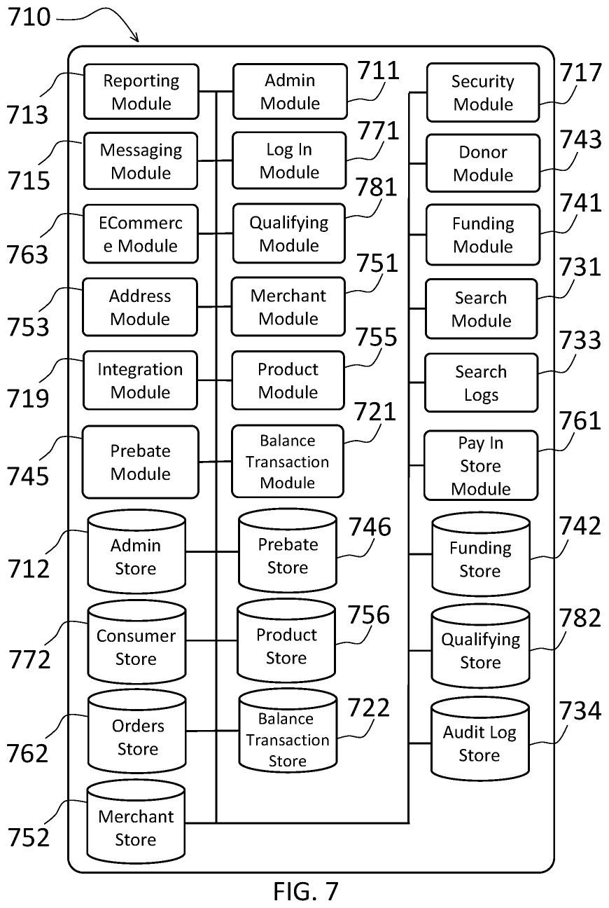

FIG. 7 illustrates a data distribution system 710 of a funding allocation system (e.g., funding allocation system 600 of FIG. 6). The data distribution system 710 may include a variety of modules to facilitate operations and communications throughout the funding allocation system. Modules may be software layers (e.g., on a single server and/or hard drive) that perform specified functions within data distribution system 710 and/or separate hardware components (e.g., each located on one or more different servers) having hard coding and/or software to enable performance of specified functions within data distribution system 710. Data distribution system 710 may include a number of data storage components (e.g., memory in the form of tabulated data, cataloged data, lists, hyperlinks to data stored elsewhere, and so forth) for storing data collected, used, and transmitted during operations and communications of the funding allocation system. The data storage components may be segmented portions of a unitary digital memory and/or each data storage component may be housed separately of one or more of the other data storage components (e.g., one separate hard drives and/or in separate geographical locations for operational security).

Data distribution system 710 may include a balance transaction module 721. Balance transaction module 721 may facilitate the receipt of funds from contributing entities and/or NPOs (e.g., from a funding source system into a fund account). Actual funding (e.g., funding data) may be transferred from a financial account of the contributing entity and/or NPO into a financial account of the data distribution system 710 (e.g., the fund account). Balance transaction module 721 may collect transaction data regarding this transfer of funding data and/or regarding any subsequent allocation (e.g., to a consumer user's digital wallet) and/or any subsequent transfer of funding data (e.g., to a retailer's financial account as payment for products and/or services). Balance transaction module 721 may allocate and/or transfer funding data to and/or from users (e.g., consumers, retailers, manufacturers, NPOs, and contributing entities). Balance transaction module 721 may add and subtract funding from the fund account (e.g., based on allocations and/or transfers). Balance transaction module 721 may perform allocations and/or transfers in order to process refunds. Balance transaction module 721 may perform allocations and/or transfers in order to process charge backs. Balance transaction module 721 may allocate and/or transfer funding as part of a tax credit.

Data distribution system 710 may include a balance transaction storage 722. Balance transaction storage 722 may house one or more fund accounts (e.g., one or more fund accounts for each contributing entity and/or NPO), including account balance, credits to the fund account, allocations from the fund account, withdrawals from the fund account, and so forth. Balance transaction storage 722 may store transaction data (e.g., transaction data collected by balance transaction module 721). Balance transaction storage 722 may balance transactions. Balance transaction storage 722 may perform reconciliation of financial accounts (e.g., reconciliation against a funding storage 742).

Data distribution system 710 may include a funding module 741. Funding module 741 may facilitate the receipt of funding from contributing entities and/or NPOs (e.g., facilitating the communication and/or transfer of funding data between financial accounts of the contributing entities and/or NPOs and the fund accounts monitored by balance transaction module 721). Funding module 741 may interface with a funding source system and with balance transaction module 721 to enable the transfer of funding data.

Data distribution system 710 may include a funding storage 742. Funding storage 742 may store transaction data (e.g., transaction data collected by funding module 741 and/or balance transaction module 721). Funding storage 742 may provide a separate data set to use for reconciliation of the data stored in balance transaction storage 722 (e.g., as a layer of protection against fraud, data loss, or otherwise). Funding storage 742 may store swift numbers, ACH numbers, and other financial transaction information. Funding storage 742 may catalog and/or store transaction information for all funding data transfers (e.g., contributing entity, NPO, amount contributed, date, financial account information, digital wallet information, and so forth).

Data distribution system 710 may include a donor module 743. Donor module 743 may collect and store information about persons, groups, companies, governments, NPOs, or other entities (e.g., donors) who contribute funding (e.g., funding data) into a fund account. Donor module 743 may collect donor name, type of organization, contribution history, funding programs used, or other information about the donors.

Data distribution system 710 may include a prebate module 745. Prebate module 745 may facilitate the creation of funding programs with any number of conditions. Prebate module 745 may allocate funding (e.g., prebates) within the funding program based on the conditions as specified in the funding program. When a consumer user qualifies under a funding program, funding (e.g., funding data) may be allocated to the consumer user's digital wallet for use in accordance with the conditions prescribed in the funding program. Funding may remain in the fund account (e.g., funding may be allocated to, but not transferred to the consumer user's digital wallet). Balance transaction module 721 may track the amounts allocated to a consumer user's digital wallet, and may generate an adjusted total based on the allocated amount. Balance transaction module 721 may track an actual total (e.g., the gross total) of funding in the fund account and an adjusted total less allocations to consumer users' digital wallets (e.g., the allocated total).

Data distribution system 710 may include a prebate storage 746. Prebate storage 746 may catalog and/or store information about prebate programs. Prebate storage 746 may catalog and/or store the conditions established within each prebate program.

Data distribution system 710 may include a pay-in-store module 761. Pay-in-store module 761 may interface with a consumer system (e.g., a mobile application operable on an electronic device of the consumer user). Pay-in-store module 761 may interface with a retail system (e.g., a POS application operable on an electronic device of the retailer). Pay-in-store module 761 may facilitate in-store purchases of products and/or services using funding held in the fund account (e.g., as allocated to the consumer user for purchases of products and/or services). Pay-in-store module 761 may interface with balance transaction module 721 to determine an amount of funding to be used for a purchase of products.

When a consumer user purchases products using allocated funds, the amount of allocated funds used for the purchase may be subtracted from the consumer user's digital wallet. The transaction reflecting the change in allocated funds may be stored in data distribution system 710 (e.g., in consumer storage 772, orders storage 762, balance transaction storage 722, and/or audit log storage 734). Further, when the consumer user purchases products with allocated funds, actual funding (e.g., from the fund account) may be transferred to an account of the retailer from whom products were purchased. The balance in the fund account may be adjusted to account for this data transfer of funding to the retailer (e.g., the gross total may be adjusted). The transaction reflecting the change in actual funding may be stored in data distribution system 710 (e.g., in balance transaction store 722, funding store 742, and/or audit log store 734).

Pay-in-store module 761 may relay communications between the consumer system and the retail system. Alternatively, the consumer system may utilize near field communication (NFC) to communicate directly with the retail system (e.g., with communications relayed back to pay-in-store module and/or balance transaction module 721 to enable transfer of funding data). Alternatively, the consumer system may utilize radio-frequency identification (RFID) to communicate directly with the retail system. Alternatively, the consumer system may utilize Bluetooth to communicate with the retail system. Pay-in-store module 761 may interface with one or more third-party payment systems (e.g., mobile payment applications). Pay-in-store module 761 may collect transaction receipts for purchases (e.g., detailing the date of purchase, time of purchase, consumer user making the purchase, products purchased with funding, products purchased without funding, amount of funding used per product, and so forth).

The data distribution system 710 may include an e-commerce module 763. E-commerce module 763 may provide a digital and/or virtual buying process (e.g., internet-based website with product pages for different products). E-commerce module 763 may enable digital purchasing (e.g., digital shopping cart with electronic payment capabilities). E-commerce module 763 may facilitate virtual and/or online purchases of products and/or services using funding held in the fund account (e.g., as allocated to the consumer user for purchases of products and/or services). E-commerce module 763 may interface with balance transaction module 721 to determine an amount of funding to be used for a purchase. E-commerce module 763 may collect transaction receipts for purchases (e.g., detailing the date of purchase, time of purchase, consumer user making the purchase, products purchased with funding, products purchased without funding, amount of funding used per product, and so forth).

Data distribution system 710 may include an order storage 762. Order storage 762 may store purchase receipts, transaction history, and other details (e.g., collected by pay-in-store module 761 and/or collected by e-commerce module 763).

Data distribution system 710 may include an administration module 711. Administration module 711 may handle backend system operations. Administration module 711 may handle refunding. Administration module 711 may handle reconciliation. Administration module 711 may perform reporting (e.g., generating reports on key metrics, including without limitation, money donated, money allocated, money spent, generating reports on all orders, orders at each business, orders at each location, orders for each family, orders for each individual, transaction history, take rate of prebates, products purchased, prices of products purchased, categories of products purchased, and reporting on any other metric presented in this disclosure or known in the art). Administration module 711 may perform auditing on all operations and communications within the funding allocation system (e.g., as between balance transaction storage 722 and funding storage 742). Administration module 711 may enable administrators to set up, edit (e.g., change of name), and/or delete user accounts.

Data distribution system 710 may include an administration storage 712. Administration storage 712 may collect and store data, tables, and reports that track behavior within the funding allocation system (e.g., any of the reporting and/or metrics presented in this disclosure or known in the art). Administration storage 712 may be available only to administrative personnel. Some parts of administration storage 712 may be available to specified users of the funding allocation system (e.g., consumers, retailers, manufacturers, NPOs, contributing entities may have limited access to query reports containing specific data relevant to them, and/or reports containing information on broad trending).

Data distribution system 710 may include a reporting module 713. Reporting module 713 may collect data to prepare reports (e.g., reporting as described in this disclosure). Reporting module 713 may collect data to prepare charts. Reporting module 713 may transmit reports and charts to administration storage 712.

Data distribution system 710 may include a messaging module 715. Messaging module 715 may regulate and/or control all communications going into or out of data distribution system 710. Messaging module 715 may interfacing with email systems. Messaging module 715 may interface with text messaging systems. Messaging module 715 may interface with social media systems. Messaging module 715 may interface with security module 717 to protect against fraud, scams, hacking, or other forms of unauthorized access to data distribution system 710 and/or the funding allocation system.

Data distribution system 710 may include a security module 717. Security module 717 may control the login process (e.g., requiring multifactor authentication including verification of identity, for administrators and users). Security module 717 may oversee financial data transfers and/or financial transactions. Security module 717 may secure fund accounts. Security module 717 may oversee all communications within the data distribution system 710. Security module 717 may protect the various modules (e.g., the software) of the data distribution system 710 and/or communications between the data distribution system 710 and other elements of the funding allocation system (e.g., funding allocation system 600 of FIG. 6). Security module 717 may perform data recovery strategies. Security module 717 may perform periodic or continuous monitoring of the funding allocation system. Security module 717 may perform data encryption. Security module 717 may backup data to different physical locations.

Data distribution system 710 may include an integration module 719. Integration module 719 may enable communication with third-party systems (e.g., third-party payment systems). Integration module 719 may enable data distribution system 710 to communicate with product information management (PIM) systems (e.g., conversion and/or translation between computer system languages).

Data distribution system 710 may include a search module 731. Search module 731 may enable administrative personnel to query the funding allocation system, such as to look for reports, charts, trends and/or specific information regarding a particular operation and/or communication or set of operations and/or communications. Search module 731 may enable users to query the funding allocation system (e.g., through a login that enables access only to information related to that user and/or information about broad trends).

Data distribution system 710 may include search logs 733. Search logs 733 may catalog and/or store searches performed by search module 731. Search logs 733 may translate the search logs and/or generate reports regarding searches performed. Search logs 733 may communicate search reports back to administration module 711 (and/or to a user's login portal).

Data distribution system 710 may include an audit log storage 734. Audit log storage 734 may record and/or store every behavior (e.g., operations and/or communications) occurring in the funding allocation system. Audit log storage 734 may store audits performed by the administration module 711. Audit log storage 734 may be queried by search module 731.

Data distribution system 710 may include a merchant module 751. Merchant module 751 may collect merchant information (e.g., contact information of retailers and/or manufacturers). Merchant module 751 may collect merchant location information (e.g., addresses and contact information of each store and/or manufacturing location, where merchant has multiple locations).

Data distribution system 710 may include a merchant storage 752. Merchant storage 752 may store merchant information. Merchant storage 752 may store merchant location and geo-location information.

Data distribution system 710 may include an address module 753. Address module 753 may determine merchant geo-locations (e.g., locating on a global positioning service). Address module 753 may determine consumer user geo-locations. Address module 753 may determine which merchant is closest to a consumer user in a particular sales transaction. Geo-location information may be stored in merchant storage 752.

Data distribution system 710 may include a product module 755. Product module 755 may receive stock-keeping unit (SKU) information for products offered for sale. Product module 755 may receive SKU information for each merchant user on the funding allocation system. Product module 755 may receive SKU information for each merchant location. Product module 755 may interface with merchant module 751 (e.g., to correlate a particular merchant with that merchant's products and/or services). Product module 755 may interface with a retail system (e.g., retail system 660 of FIG. 6) and/or a manufacturer system (e.g., manufacturer system 650 of FIG. 6). Product module 755 may perform inventory tracking periodically (e.g., once daily), or constantly (e.g., live).

Data distribution system 710 may include a product storage 756. Product storage 756 may catalog and/or store SKU information for each merchant and/or for each merchant location in merchant module 751. Product storage 756 may enable inventory tracking of each SKU for each merchant and/or merchant location. Product storage 756 may receive and/or store inventory tracking information gathered by product module 755 periodically (e.g., once daily), or constantly (e.g., live).

Data distribution system 710 may include a login module 771. Login module 771 may enable new users (e.g., consumers, retailers, manufacturers, NPOs, contributing entities) to sign up and/or create a new account. Login module 771 may allow users to login to existing accounts. Login module 771 may interface with security module 717 to provide user authentication and/or identity verification prior to granting account access.

New users may create a new account appropriate for the type of use for which they will access the data distribution system 710. Consumer users may create a consumer account. A consumer account may have access to specific modules (e.g., pay-in-store module 761). Merchants may create a merchant account. A merchant account may be connected to specific modules (e.g., merchant module 751, product module 755, and so forth). NPOs may create an NPO account. An NPO account may be connected to specific modules (e.g., funding module 741, donor module 743, and so forth). Contributing entities may give donations to NPOs in order to get tax incentives, or may contribute directly to data distribution system 710 (e.g., with a merchant account). Merchants may be able to give donations through an NPO and/or directly to data distribution system 710.

Data distribution system 710 may include a consumer storage 772. Consumer storage 772 may store consumer information (e.g., personal identification information). Consumer storage 772 may store the consumer user's transaction and/or purchase history. Consumer storage 772 may store the consumer user's funding transactions.

Data distribution system 710 may include a qualifying module 781. Qualifying module 781 may qualify users to participate in funding allocation system. Qualifying module 781 may qualify consumer users to participate in funding programs based on the satisfaction of one or more conditions required by each funding program. Qualifying module 781 may qualify consumer users to participate in funding programs based on background information obtained from third parties (e.g., obtained from qualifying system 680 of FIG. 6).

Data distribution system 710 may include a qualification storage 782. Qualification storage 782 may catalog and/or store qualifying information obtained by qualifying module 781 for each user.

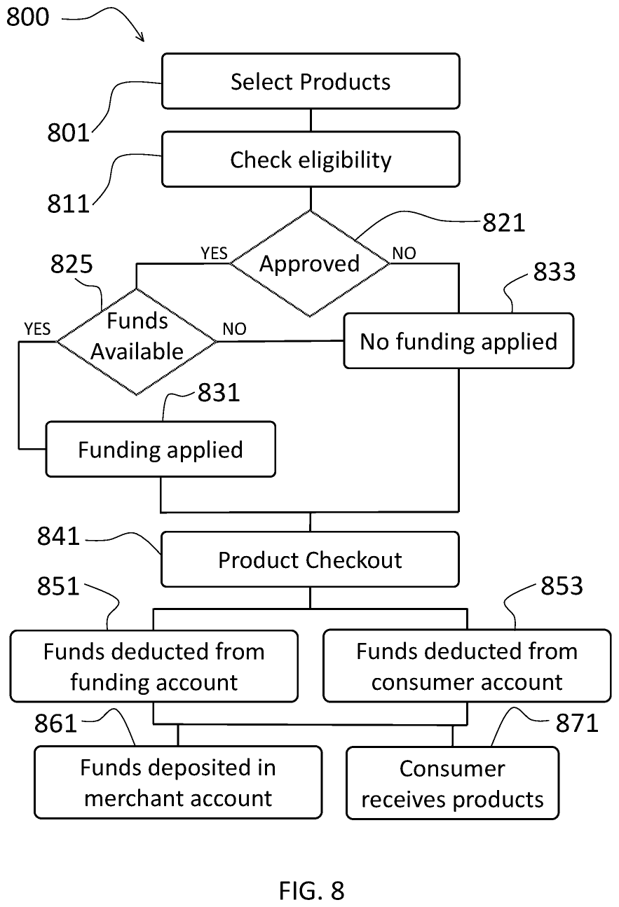

FIG. 8 illustrates one operation (e.g., a checkout flow 800) of a funding allocation system (e.g., funding allocation system 600 of FIG. 6). Consumer users may purchase products at brick-and-mortar locations and/or through a virtual portal accessible via a network (e.g., the internet). The checkout flow for a brick-and-mortar transaction may be roughly similar to the checkout flow for a virtual transaction.

At step 801, the consumer user may pick out products to be selected by a retail system (e.g., retail system 660 of FIG. 6). In a brick-and-mortar transaction products may be collected into a shopping cart, basket, bag or simply carried by the consumer user. The consumer user may transport the products to a retail register (e.g., a self-check-out-type register, or a traditional staffed register). The products may be selected by the register (e.g., “rung-up” or scanned) so that they may be listed by the register with a total price. In a virtual transaction the consumer user may click on an add-to-cart-type feature or button on the product page of the product being viewed to add the product to a virtual shopping cart. This process may be repeated until the consumer user has added all desired products to the virtual shopping cart. Adding the products to the virtual shopping cart may also cause them to be selected by a virtual register (e.g., the products added to cart may be automatically displayed on a list of items in the shopping cart with a total price. Thus, the retail system may be physical or virtual.

At step 811, the funding allocation system may check eligibility. Checking eligibility may include checking the eligibility of the consumer user to receive funding (e.g., determining whether the consumer user satisfies conditions established by the NPO providing the funding). Checking eligibility may include checking the eligibility of the products selected by the consumer user in step 801 to determine whether the products qualify for funding (e.g., determining whether the products satisfy conditions established by the contributing entity providing the funding). Checking eligibility may include checking both the eligibility of the consumer user and the eligibility of the products to receive funding (e.g., based on multiple conditions that may need to be satisfied to obtain the funding).

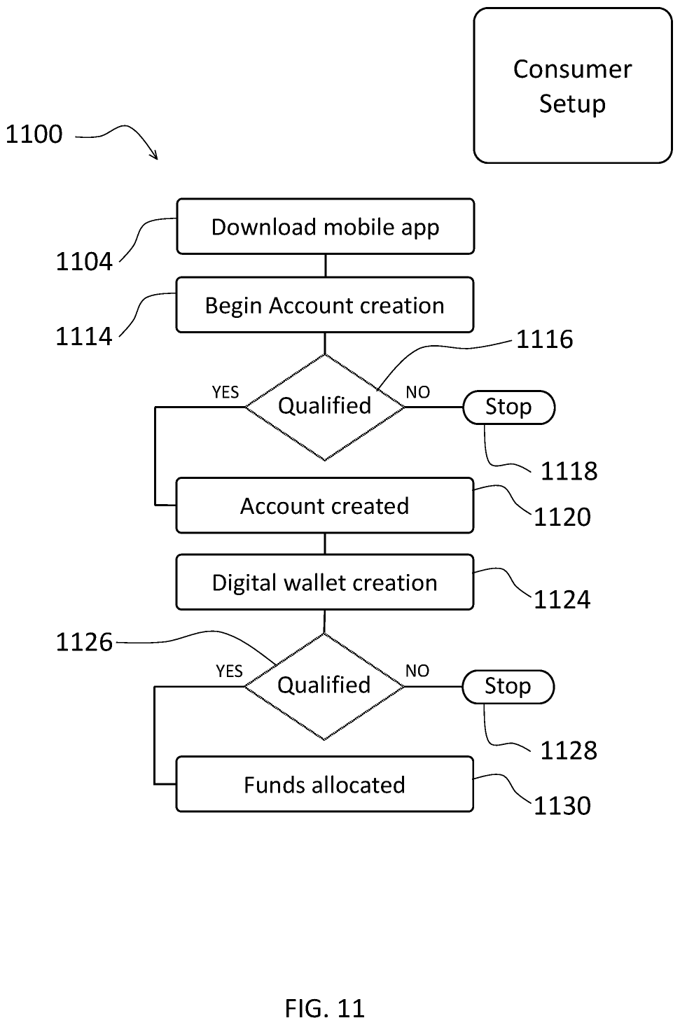

Step 821 may represent a decision point. After performing step 811, the funding allocation system may relay qualification status back to the retail system so that funding may or may not be applied to the total price. The retail system may perform step 811 internally based on stored information as presented in this disclosure, and at step 821 may transmit qualification status from storage back to the list of products so that funding may or may not be applied to the total price. The consumer user may have been prequalified to receive funding for the purchase of specified products (e.g., as exemplified on FIG. 11). In this case, funds may have already been allocated to the consumer user's digital wallet for use purchasing specified products. Therefore, the approval or non-approval of the use of allocated funds based on other conditions may occur automatically.

Step 825 may represent a decision point. After the use of funding is approved at step 821 (corresponding to the “YES” pathway), the funding allocation system may relay the availability of funding back to the retail system. Retail system may receive a communication regarding the availability of funding in the consumer user's digital wallet from a data distribution system (e.g., data distribution system 710 of FIG. 7). An availability of funding communication may be received by the retail system from a balance transaction module 721, a pay-in-store module 761, and/or an e-commerce module 763 (e.g., via an integration module 719).

At step 831, after funding is determined to be available at step 825 (e.g., corresponding to the “YES” pathway), funding may be applied to the total price of products to be purchased. Within the retail system, allocated funding may be illustrated as applied to the purchase price of the qualifying product(s) (e.g., covering some or all of the purchase price), such that an adjusted total may be represented on the retail system (e.g., the total price less the amount of allocated funding applied).

At step 833, either after funding is not approved at step 821 or after funding is determined not to be available at step 825 (e.g., corresponding to each of the “NO” pathways), funding may be withheld from the total price of products to be purchased. If the consumer user qualifies but the product does not qualify, if the consumer user does not qualify but the product qualifies, or if neither the consumer user nor the product qualify for funding, funding may be withheld (e.g., no reduction in the price to be paid by the consumer user). Further, if no allocated funding is available or not enough allocated funding is available, funding may be withheld (e.g., no reduction in the total price).

At step 841, the transaction may proceed to checkout (e.g., through a payment processing device) and the amount to be paid by the consumer user may be finalized (e.g., the amount to be paid by the consumer user plus the funding awarded may equal the total price). The retail system may total an amount of funding applied to the total price for all qualifying products and may determine a remaining balance (e.g., the price to be paid by the consumer user). During checkout, the retail system may request funds from the data distribution system (e.g., from balance transaction module 721, balance transaction store 722, and/or the fund account) in the amount of the allocated funding provided by the consumer user and/or may request payment from the consumer user's financial account (e.g., a credit card, debit card, check, cash, or other digital form of payment) for any amount not covered by allocated funding provided by the consumer user.

At step 851, the data distribution system may deduct funds (e.g., funding data) from the fund account in the amount of the allocated funding applied to the total price.

At step 853, the consumer user's financial account system may deduct funds from the consumer user's financial account (e.g., a personal checking account) to pay the remaining balance. Steps 851 and 853 may occur in tandem or at different times, and the completion of one may not depend on the completion of the other. Step 851 may be processed prior to step 853 to ensure that funding is received to cover allocated funding before collecting the remaining balance in step 853, such that if funding can't be collected at step 851, the remaining balance collected at step 853 may equal the total price without reduction.

At step 861, the funding collected at step 851 and/or the remaining balance collected at step 853 may be deposited into the merchant's financial account. Funding (e.g., funding data) from the fund account may be transferred to the merchant's financial account (e.g., a business checking account). Payment from the consumer user's financial account may be transferred to the merchant's financial account (e.g., a business savings account).

At step 871, the consumer user may receive the products purchased. In a brick-and-mortar transaction the consumer user may collect the products purchased and depart from the store. In a virtual transaction, the merchant may collect the products purchased (e.g., such as from a distribution warehouse) and ship the products to the consumer user.

While the above checkout flow 800 has been described with reference to products made available for purchase by a merchant, this disclosure contemplates the sale of services made available for purchase by a merchant.

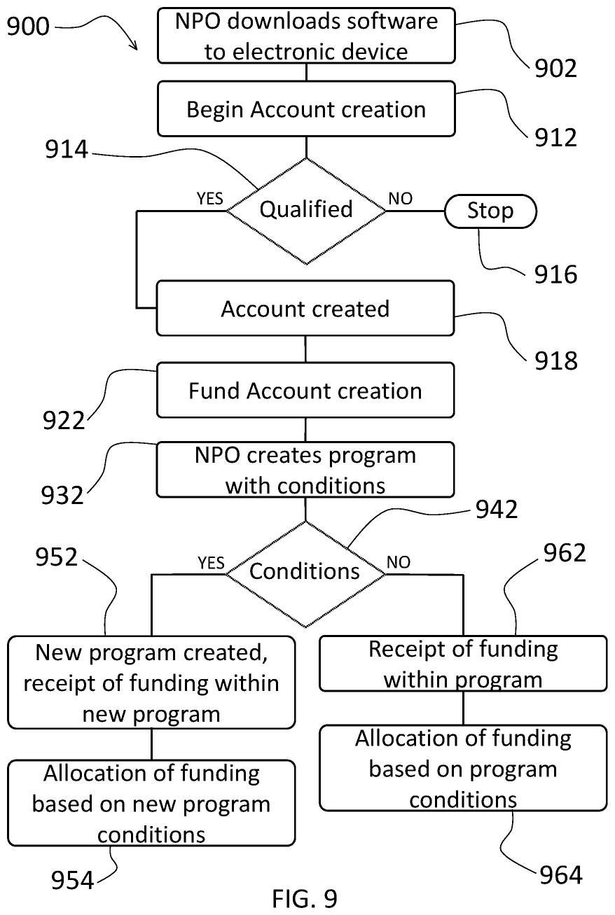

FIG. 9 illustrates one operation (e.g., an NPO account setup 900) of a funding allocation system (e.g., funding allocation system 600 of FIG. 6). The NPO account setup 900 may enable the collection of funding (e.g., donations) from various individuals, entities, and/or agencies and the dispersement and/or data transfer of funding based on conditions established by one or more NPOs and/or one or more contributing entities (e.g., manufacturers).

At step 902, an NPO applicant may download software to an electronic device (e.g., downloading a mobile application onto a cellular phone). The software may allow integration and/or synchronization with the funding allocation system (e.g., digital communications, monetary transfers, and/or reporting of metrics between the NPO's electronic device and a data distribution system).

At step 912, the NPO applicant may begin an account creation process. The NPO applicant may access the newly created account through an access portal (e.g., a login page). The NPO applicant may be required to enter name, contact information, business entity information and a user name and password in order to create an account.

Step 914 may represent a decision point. After beginning account creation at step 912, the funding allocation system may use information provided at step 912 to qualify the NPO applicant. Qualification may include identity verification, background checks, credit checks, and so forth, as described in this disclosure. Funding allocation system may perform step 914 internally (e.g., via a qualifying module, a log in module, a security module, a donor module and/or based on information contained in a qualifying storage). Qualification status may be communicated back to NPO account setup 900 and/or to the NPO applicant attempting to setup an account on the funding allocation system.

At step 916, after an NPO applicant is not approved at step 914 (e.g., corresponding to the “NO” pathway), the process may end, such that an account may not be created and/or the NPO applicant may not be given access to an account.

At step 918, after an NPO applicant is approved at step 914 (e.g., corresponding to the “YES” pathway), the account may be created and/or the NPO applicant may become verified (e.g., become an NPO user).

At step 922, at least one fund account may be created and associated with the NPO user, though a plurality of fund accounts may be created and associated with the NPO user (e.g., between about 1 and about 100 fund accounts, or more). The fund account may be synchronized and/or interconnected with the NPO user's financial accounts, and may enable transfer of funding data between the NPO user's financial accounts and the one or more fund accounts. An NPO user may request one or more additional fund accounts as needed. An NPO user may request one or more fund accounts be closed and/or deleted.

At step 932, the NPO user may create one or more funding programs with predefined conditions for regulating the allocation and/or transfer of funding data from corresponding fund accounts. Each funding program may be correlated to a specific fund account. A plurality of funding programs may be correlated to a specific fund account. The data distribution system may ensure robust tracking of transfers into or out of each funding program and/or each fund account.

Step 942 may represent a decision point. After performing either step 922, step 932, or both, the NPO user may be ready to receive funding (e.g., charitable donations and contributions). Funding may originate from one or more contributing entities. Funding may be bestowed and/or transferred to the NPO user with or without conditions attached. Therefore, funding may be handled differently depending on any conditions imposed on the use of the funding by the contributing entity.

At step 952, after funding is received with conditions attached (e.g., corresponding to the “YES” pathway), a new funding program may be created (e.g., and/or a new fund account created). Funding may be received into the new funding program and/or new fund account with conditions imposed by the contributing entity (e.g., the funding account may specify the conditions attached to the allocation and/or transfer of the funding data). Funding may be received and processed outside of any program with predefined conditions established by the NPO user.

At step 954, funding may be allocated and/or transferred based on the satisfaction of the conditions established by the contributing entity (e.g., funding may be allocated to a consumer user if that consumer user meets the conditions imposed by the funding program).

At step 962, after funding is received without conditions attached (e.g., corresponding to the “NO” pathway), funding may be received into a preexisting funding program (e.g., a funding program created in step 932). The contributing entity may select the funding program to which funding will be transferred. Where a contributing entity hasn't specified a preexisting funding program, the NPO user may select the funding program to which funding will be transferred.

At step 964, funding may be allocated and/or transferred based on the satisfaction of the conditions established within the funding program (e.g., funding may be transferred to a retailer if the products purchased by a consumer user meet the conditions imposed by the funding program).

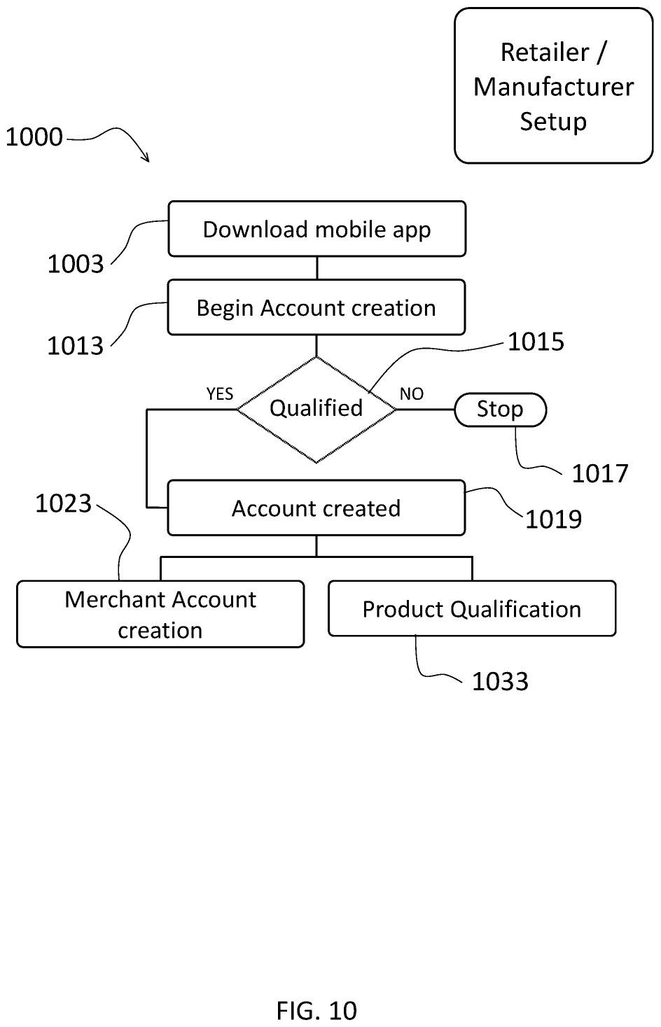

FIG. 10 illustrates one operation (e.g., a merchant account setup 1000) of a funding allocation system (e.g., the funding allocation system 600 of FIG. 6). The merchant account setup 1000 may enable the allocation and/or transfer of funding data for a set of cataloged products made and/or sold by one or more manufacturer users and/or sold by one or more retailer users.

At step 1003, a merchant applicant may download software to an electronic device (e.g., downloading a software program onto a computer system). The software may allow integration and/or synchronization with the funding allocation system (e.g., digital communications, monetary transfers, and/or reporting of metrics between the merchant applicant's electronic device and a data distribution system).

At step 1013, the merchant applicant may begin an account creation process. The merchant applicant may access the newly created account through an access portal (e.g., a login page). The merchant applicant may be required to enter name, contact information, business entity information and a user name and password in order to create an account.

Step 1015 may represent a decision point. After beginning account creation at step 1013, the funding allocation system may use information provided at step 1013 to qualify the merchant applicant. Qualification may include identity verification, background checks, credit checks, and so forth, as described in this disclosure. Funding allocation system may perform step 1015 internally (e.g., via a qualifying module, a log in module, a security module, a donor module and/or based on information contained in a qualifying storage). Qualification status may be communicated back to merchant account setup 1000 and/or to the merchant applicant attempting to setup an account on the funding allocation system.

At step 1017, after a merchant applicant is not approved at step 1015 (e.g., corresponding to the “NO” pathway), the process may end, such that an account may not be created and/or the merchant applicant may not be given access to an account.

At step 1019, after a merchant applicant is approved at step 1015 (e.g., corresponding to the “YES” pathway), the account may be created and/or the merchant applicant may become verified (e.g., a merchant user, such as a manufacturer user and/or retailer user).

At step 1023, a merchant account may be created. The merchant account may receive allocated funds and/or actual funding (e.g., funding data may be transferred as payment for products purchased by a consumer user, and/or money may be withdrawn as part of a refund process, and/or money may be deposited and/or withdrawn as part of a rebate program). A merchant account may be preferable over using the merchant user's financial account, since obtaining funding data transfers from the merchant user's financial account may require active effort by the merchant user and/or extra steps (e.g., invoicing).

At step 1033, a merchant user's account may be integrated and/or synchronized with the merchant user's PIM system (e.g., to enable products made and/or sold by the merchant user and corresponding product information to be stored as part of the merchant user's account). Each product may be qualified under one or more funding programs as presented in this disclosure.

FIG. 11 illustrates one operation (e.g., a consumer account setup 1100) of a funding allocation system (e.g., the funding allocation system 600 of FIG. 6). The consumer account setup 1100 may enable the consumer user to purchase products and/or services using allocated funding from the consumer user's digital wallet.

At step 1104, a consumer applicant may download software to an electronic device (e.g., downloading a mobile application onto a smart device). The software may allow integration and/or synchronization with the funding allocation system (e.g., digital communications, monetary transfers, and/or reporting of metrics between the consumer applicant's electronic device and a data distribution system).

At step 1114, the consumer applicant may begin an account creation process. The consumer applicant may access the newly created account through an access portal (e.g., a login page). The consumer applicant may be required to enter name, contact information, business entity information and a user name and password in order to create an account.

Step 1116 may represent a decision point. After beginning account creation at step 1114, the funding allocation system may use information provided at step 1114 to qualify the consumer applicant. Qualification may include identity verification, background checks, credit checks, and so forth, as described in this disclosure. Funding allocation system may perform step 1116 internally (e.g., via a qualifying module, a log in module, a security module, a donor module and/or based on information contained in a qualifying storage). Qualification status may be communicated back to consumer account setup 1100 and/or to the consumer applicant attempting to setup an account on the funding allocation system.

At step 1118, after a consumer applicant is not approved at step 1116 (e.g., corresponding to the “NO” pathway), the process may end, such that an account may not be created and/or the consumer applicant may not be given access to an account.

At step 1120, after a consumer applicant is approved at step 1116 (e.g., corresponding to the “YES” pathway), the account may be created and/or the consumer applicant may become verified (e.g., become a consumer user).

At step 1124, a consumer user's digital wallet may be created. The digital wallet may operate as a financial account for purchasing products and/or services, except that the digital wallet may only receive allocated funds and the use of the funds may be limited by conditions on the consumer user and/or conditions on the products and/or services to be purchased.

Step 1126 may represent a decision point. After digital wallet creation at step 1124, the funding allocation system may use information provided at step 1114 to qualify the consumer user for funding programs. Funding allocation system may perform step 1126 internally (e.g., via a qualifying module, a prebate module, and/or based on information contained in a qualifying storage and/or prebate storage). Qualification status may be communicated back to consumer account and/or to the consumer user attempting to qualify for one or more funding programs on the funding allocation system.

At step 1128, after a consumer user is not approved for a particular funding program at step 1126 (e.g., corresponding to the “NO” pathway), the process may end, such that the consumer user may not be allocated funding from the one or more funding programs applied for. An administrator may be able to override any decision points presented in this disclosure (e.g., via an administration module).

At step 1130, the consumer user's digital wallet may receive allocated funds and/or actual funding (e.g., funding data may be allocated upon satisfaction of conditions associated with a funding program).

Having described several embodiments, various extensions and alternatives may be readily apparent to those of skill in the art. Such extensions and alternatives are considered to be part of the invention, which is only limited by the several claims attached hereto. Other aspects will be apparent to those skilled in the art from consideration of the specification and practice disclosed herein. It is intended, therefore, that the specification and illustrated embodiments be considered as examples only.

What is claimed is:

1. A funding allocation system, comprising:
a network capable of electronic communication and transfer of funding;
a data distribution system coupled to the network, wherein the data distribution system sends and receives communications and controls funding data for transfers and allocations throughout the funding allocation system, wherein funding data is transferred into the data distribution system;
a retail system coupled to the network, wherein the retail system receives product eligibility information from the data distribution system for each product made available for purchase;
a consumer system coupled to the network, wherein the data distribution system allocates funding to a consumer user of the funding allocation system through funding data showing allocated funding for the consumer user, wherein the consumer user accesses the allocated funding through the consumer system, and wherein the consumer user utilizes the allocated funding to purchase products from the retail system.

2. The funding allocation system of claim 1, including a funding source system coupled to the network, wherein a contributing entity transfers funding to the funding source system.

3. The funding allocation system of claim 1, including a funding source system coupled to the network, wherein a non-profit organization user of the funding allocation system transfers funding from the funding source system to the data distribution system.

4. The funding allocation system of claim 1, including a manufacturer system coupled to the network, wherein a manufacturer user of the funding allocation system transfers product information from the manufacturer system to the data distribution system.

5. The funding allocation system of claim 1, including a qualifying system coupled to the data distribution system, wherein the qualifying system determines whether the consumer user is eligible to receive allocated funding.

6. A data distribution system, comprising:
a balance transaction module capable of sending and receiving communications and funding data transfers for allocation throughout the data distribution system;
a consumer storage capable of receiving allocated funding data to be used by a consumer to purchase products, wherein funding data indicating a specified amount is allocated by the balance transaction module to the consumer storage; and
one or both of a pay-in-store module and an e-commerce module capable of retrieving the allocated funding data and applying the allocated funding data to a total price of products to be purchased;
wherein funding data in the specified amount of the allocated funding data is transferred by the balance transaction module through one or the other of the pay-in-store module and the e-commerce module to provide payment for the products.

7. The data distribution system of claim 6, including a funding module that gathers transaction information on funding transfers through one of a funding source system and a manufacturer system, and including a funding storage that stores the transaction information.

8. The data distribution system of claim 6, including a merchant module that collects merchant information from one or both of a manufacturer system and a retail system, and including a merchant storage that stores the merchant information.

9. The data distribution system of claim 6,
including a product module that receives product information from a manufacturer system, and including a product storage for storing the product information.

10. The data distribution system of claim 6, including a qualifying module that receives consumer qualification information from a qualifying system, and including a qualifying storage for storing the consumer qualification information.

11. The data distribution system of claim 6, including a donor module that collects one or both of contributing entity information from a contributing entity and non-profit organization information from an non-profit organization and that collects conditions imposed on use of the funding donated by one or both of the contributing entity and the non-profit organization.

12. The data distribution system of claim 11, including a prebate module that receives product information and determines a qualification status of each product based on conditions imposed on the use of the funding, and including a prebate storage for storing the qualification status of products.

13. The data distribution system of claim 6, wherein one or both of the pay-in-store module and the e-commerce module receives one or both of product qualification status and consumer qualification information to determine whether allocated funding is applied to a product for purchase by a consumer user.

14. A funding allocation system having a data distribution system with a balance transaction module capable of sending and receiving communications and funding transfers throughout the funding allocation system, a consumer storage capable of receiving allocated funding to be used by a consumer to purchase products, and one or both of a pay-in-store module and an e-commerce module capable of retrieving the allocated funding from the consumer storage, the funding allocation system comprising:
a network capable of electronic communication and transfer of funding;
the data distribution system coupled to the network, wherein funding data is transferred into the balance transaction module;
a retail system coupled to the network, wherein the retail system receives product eligibility information from the data distribution system for each product made available for purchase;
a consumer system coupled to the network, wherein the balance transaction module allocates funding data to the consumer storage, wherein the consumer accesses the allocated funding through the consumer system, wherein one of the pay-in-store module and the e-commerce module apply the allocated funding to a total price of products to be purchased, and wherein the consumer uses the allocated funding to purchase the products from the retail system.

15. The funding allocation system of claim 14, wherein the data distribution system includes a funding module that facilitates communication between the balance transaction module and one of a funding source system and a manufacturer system to process funding transfers.

15. The funding allocation system of claim 14, wherein one or both of the pay-in-store module and the e-commerce module facilitates one or both of communication and funding transfers between the balance transaction module and the retail system.

16. The funding allocation system of claim 14, wherein the data distribution system includes one of a merchant module and a product module that facilitate one or both of communication and funding transfers between the balance transaction module and one of a manufacturer system and the retail system, and including one or both of a merchant storage that stores merchant information and a product storage that stores product information.

17. The funding allocation system of claim 14, wherein the data distribution system includes a product module and a product storage, and wherein the product module facilitates communication between the product storage and a manufacturer system to collect and store product information.

18. The funding allocation system of claim 14, including a qualifying system that generates consumer qualification information, and wherein the data distribution system includes a qualifying module that facilitates communication between the consumer storage and the qualifying system.

19. The funding allocation system of claim 14, wherein the data distribution system includes a donor module and a prebate module, wherein the donor module generates and communicates conditions imposed on the use of the funding to the prebate module, wherein the prebate module receives product information and determines qualification status of each product based on conditions imposed on the use of the funding, and wherein the data distribution system includes a prebate storage that stores qualification status information of products.

20. The funding allocation system of claim 19, wherein during the purchase of products, one or both of the pay-in-store module and the e-commerce module receive qualification status information from the prebate storage to determine whether products qualify for the application of allocated funding before the allocated funding is applied to a total price of products to be purchased.
